(19) United States
(12) Patent Application Publication
(10) Pub. No.: US 2025/0185618 A1
(43) Pub. Date: Jun. 12, 2025

(54) Flushing toilet for a dog

(71) Applicant: Geoffrey P. Champion, South Plainfield, NJ (US)

(72) Inventor: Geoffrey P. Champion, South Plainfield, NJ (US)

(21) Appl. No.: 19/060,823

(22) Filed: Feb. 24, 2025

Related U.S. Application Data
(63) Continuation of application No. 17/300,740, filed on Oct. 13, 2021, now abandoned.

(51) Int. Cl. A01K 1/01

(52) U.S. Cl. CPC A01K 1/011; A01K 1/0107

(57) ABSTRACT

An improved practical solution of a unit a dog will use to urinate and/or defecate on, and will clean itself. The unit has a post for the dog to urinate on and a based plate with the surface covered with artificial grass for the dog to defecate on. The dog would urinate on post to mark their territory and would feel comfortable to defecate on an artificial grass surface. The urination post is cleaned by water flowing down it and into a drain on the base. The deification base surface has a slight grade to help direct the feces to the drain. Water is sprayed from nozzles in motion and towards the drain to wash the surface clean of feces. Two possible solutions one for outdoor for public use, and the other for in home use.

### CROSS-REFERENCE TO RELATED APPLICATIONS

This Application is a Continuation of U.S. Non-Provisional Utility patent application Ser. No. 17/300,740 filed Oct. 13, 2021, the entire contents of which are incorporated by reference in its entirety.

### TECHNICAL FIELD OF THE INVENTION

This invention relates to flush toilet for domestic animals and more particularly relates to a flush toilet suitable for use by dogs of various physical sizes.

### BACKGROUND OF THE INVENTION

When an owner takes a dog for a walk it's for two purposes one to exercise the animal and two to allow the animal to relieve itself. Presently after a dog defecates the owner is supposed to pick it up and dispose of the feces properly. This is messy and the owner may not get all of the feces or worst may just be inconsiderate and leave it. Even if you do the right thing is it a good idea to put it in the trash.

As you are walking your dog past the unit if you bring it near the post of the toilet must male dogs smell the area and will want to urinate on it to mark their territory. As he/she is urinating it is standing on the artificial turf plate. The unit being of a consistent comfortable temperature should help the owner to train the dog to defecate on it. The owner simply uses a foot paddle or the unit could have an automatic activator to flush and clean it and wash the waist into the sewer.

When the weather is inclement and a dog must stay indoors, the dog will use the indoor version. This unit can either be flushed by the owner using a manual flush handle similar to a present day human toilet, or rely on an automated flush sensor. This unit can also be used for training dogs.

### SUMMARY OF THE INVENTION

Outdoor unit: Consisting of an upright post, a base plate in the shape a circle or portion thereof, with a cavity to provide for coolant, a mechanical foot peddle or an electronic actuator, a water supply and drain connected to a sewer.

An optional cavity will have fluid to keep the unit a constant temperature.

The urination post is in the center or towards the back standing vertical, water is brought to the top and a drain in the base. Water will flow down to clean it after the dog has urinated.

The base will be a circler or portion of a circle covered with artificial grass with a slight gradation toward the outside to help direct the feces to the drain on the outer rim. Designed for easy access.

At the base of the urination post are the spray nozzles aiming outward toward the drain. The spray nozzles will mounted on a mechanism to direct their aim back and forth allowing for better cleaning of the defecation surface.

The in-door unit: Consisting of a wall on back, an upright post for dogs to urinate on, a plate laded out as a semi-circle covered with artificial grass for dogs to defecate on, a water tank, a flush handle or an electronic actuator, a water supply and a drain.

The wall of the unit is designed to protect the wall of the home from urine or feces. These units are designed to be mounted against a wall in a bathroom or other placed in the home.

The urination post is towards the back standing vertical with a water tank on top water and a drain in the base. Water will flow down to clean it after the dog has urinated.

The base will be a portion of a circle covered with artificial grass with a slight angle toward the center to help direct the feces to the drain in the center. There will be a lip on the front where the spray nozzles will be located. All designed to reduce spillage.

The spray nozzles will be in track aiming to the center were the drain is. They will move as they spray allowing for better cleaning of the defecation surface.

### BRIEF DESCRIPTION OF THE DRAWINGS

FIG. 1 Outdoor unit Isometric of complete unit.

FIG. 2 Outdoor unit cross section of complete unit.

FIG. 3 Outdoor unit cross section urination cleaning water flow

FIG. 4 Outdoor unit defecation cleaning nozzle Isometric drawing.

FIG. 5 Overhead views of Outdoor Public use version

FIG. 6 Isometric of Indoor Dog Toilet for Small to Medium Size breads.

FIG. 7 Sectional view Indoor Dog Toilet

FIG. 8 Sectional view of Indoor Dog Toilet Water Tank and Flushing mechanism

FIG. 9 Sectional view of Indoor Dog Toilet Flushing mechanism for automatic electronic option

FIG. 10 Sectional view of water moving feces cleaning nozzle mechanism

FIG. 11 Overhead view of Indoor version of small to Medium and The Large or Multiple Dogs Toilets

### DETAILED DESCRIPTION

The flushing toilet drawings with the corresponding parts showing several views. The numbers in the descriptions refer to the numbers in the corresponding figures.

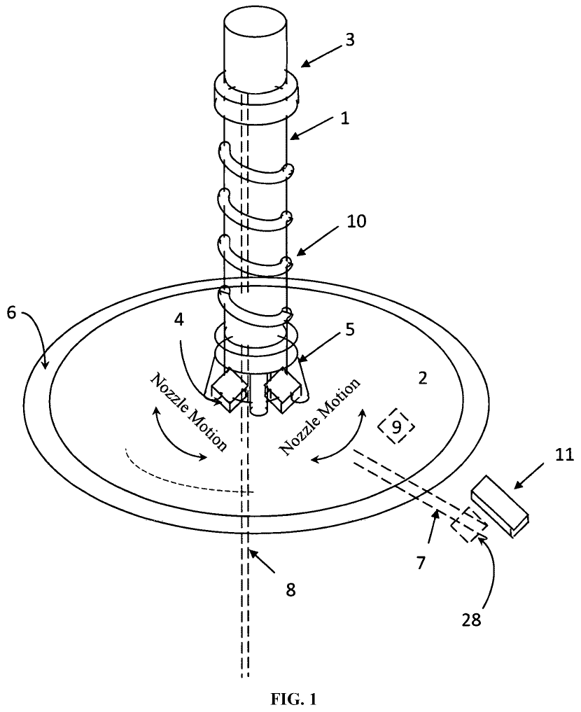

FIG. 1 is an isometric drawing which show how the unit would look as you approach it. #1 The post which can serve multiple purposes; locate the unit from a distance, vehicle control, and must important a location were a dog can urinate on. #10 The optional liquid coolant cavity; exposed to the elements all surfaces will absorb heat and/or cold from the atmosphere this can affect the ability of the unit to flush and more important make it very uncomfortable for the dog to do their business. #3 is where the water is allowed to flow over the urination post to clean it after the dog has finished urinating, located on the bottom of the urination post #5 is where the water and urine will drain. #2 the bottom plate this is where the dog defecates, covered with artificial grass and at a slight gradation so as to direct the feces to the outside toward the gap on the outer rim which is #6 the feces drain allow for the waste to go down #8 the sewer. #10 The optional liquid coolant cavity behind the surface. A #11 Foot peddle or an electric actuator to open #27 the valve, will be use to start the cleaning proses after the dog has finished. The automatic option will start by #9 a weight sensor when the dog first stands on the unit it sets the system, when the dog gets off the sensor opens #27 the value for a predetermined time then closes. The proses is to spray the post and plate with water until all feces and urine is removed and sent down the drain to the sewer. #7 Water supply and #8 Sewer are provided by the municipality.

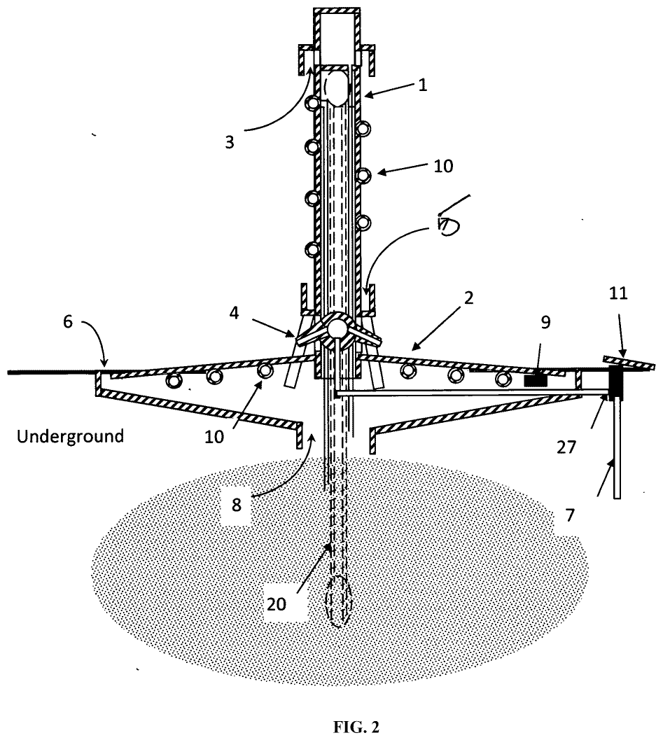

FIG. 2 is a cross section of the complete unit, showing more detailed you can see the #1 post with the #10 optional liquid coolant cavities on the outside and #3 water waterfall for the urination post and on the bottom you will see #5 the drain for the urine bellow #4 the nozzles to clean the feces off. Inside you see the #7 water supply. #20 optional antifreeze chamber approximately 10 ft. below the surface; normally water would flow through the #10 liquid coolant cavities but were water is in short supply or extreme weather other liquids could be pumped in, 1Oft bellow the earth surface is a constant temperate the liquid would transfer this to the unit above. #2 the base plate: shows an angle to drain to the outside of the plate #6 is a gap to outside for the feces to drain down #8 the sewer system below the plate. #10 liquid coolant cavities. #11 the foot peddle or electronic sensor; would control #27 the water value

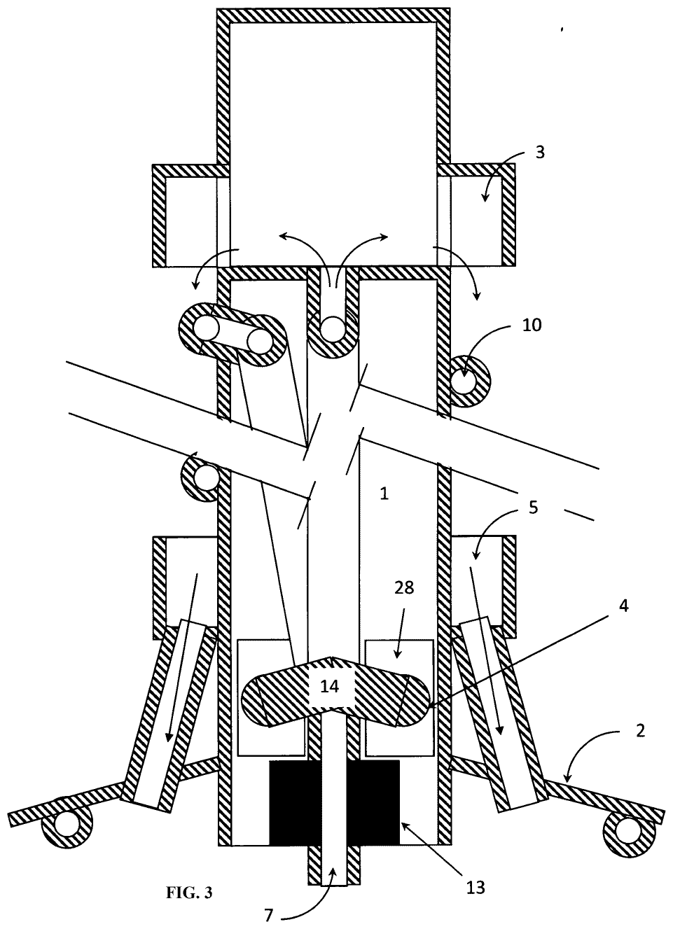

FIG. 3 shows a cross section of #1 the urination post on the top is where the #3 water will start to cascade over the post. One the outside you will see #10 the optional cavity for the water to keep the post's temperature constant. The outside of the bottom shows where the urine will be collected #5 the urine drain and sent to #8 sewer system. Inside the unit you will see #4 the feces cleaning nozzle located at the end of #14 4 way “T” sitting on #13 a mechanism similar to a lawn springer that uses water flow to move them back and forth. Inside the base #1 urine post at that point is located #28 is a cut out were #4 the feces cleaning nozzles poke out so they can shot water across #2 the defecation base to clean it. On the left and right you see the artificial turf cover angler #2 base plate with #10 the liquid cavity to control the units temperate behind it.

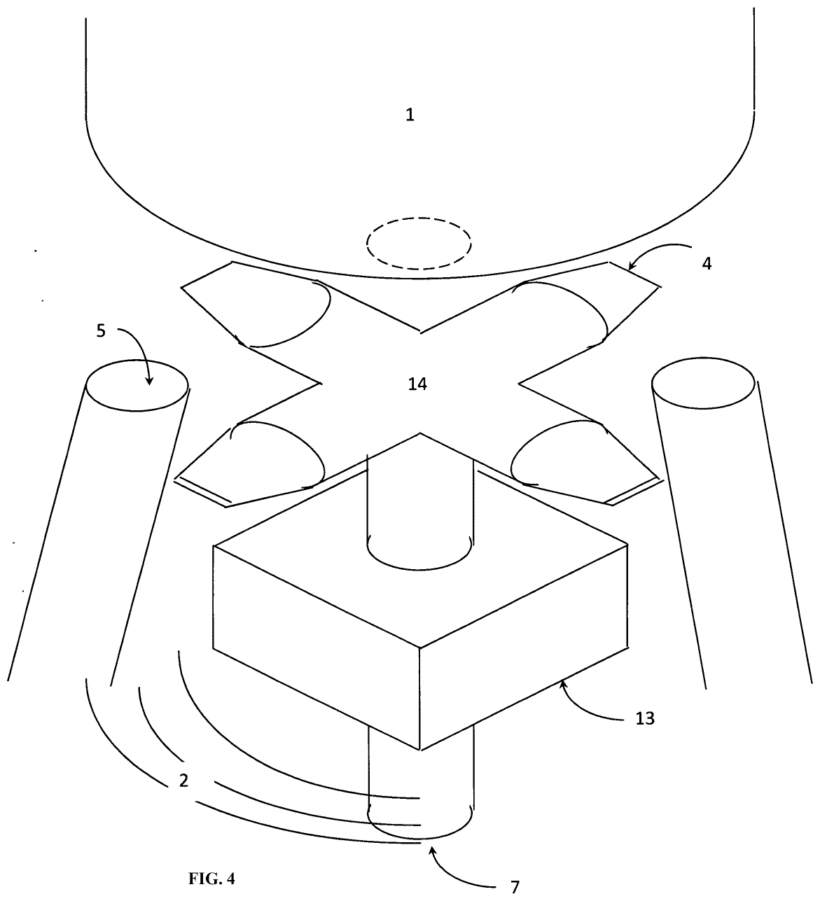

FIG. 4 shows the poo nozzle configuration located in the base of the #1 urination post. There will be 4 #4 nozzles in the free standing unit, 2 in the wall mounted unit and only one in the corner unit. As you can see by the illustration they are mounted at the end of #14 a four way water or, 2 way or just 1 ‘T’ and on top of #13 mechanism similar to a lawn sprinkler that uses water flow to move them back and forth. This greatly improves cleaning of feces of #2 the defecating plate base surface #6 the water will come from the bottom #7 from a water supply.

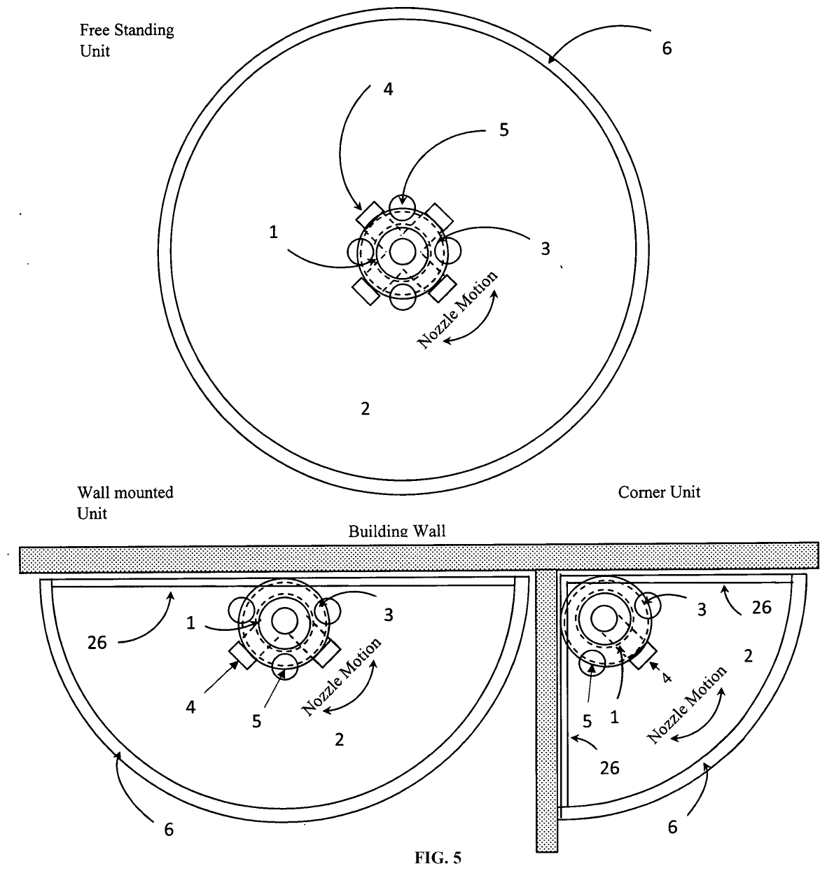

FIG. 5 Over head views of a freestanding unit, a unit mounted against a wall and a unit placed in a corner. You can see the units that are mounted against building walls will have #1 the urination post towards the back with #26 walls to protect the building from spillage mounted to the back. The free standing unit has 4 #4 feces cleaning spray nozzles the wall unit has 2 and the corner unit has 1. All units have #2 the defecation base plate with grade outward for ease of access and to assist the feces to when blasted with #4 the feces cleaning nozzles to send to #6 the waste drain on the outside of the circle or semicircle.

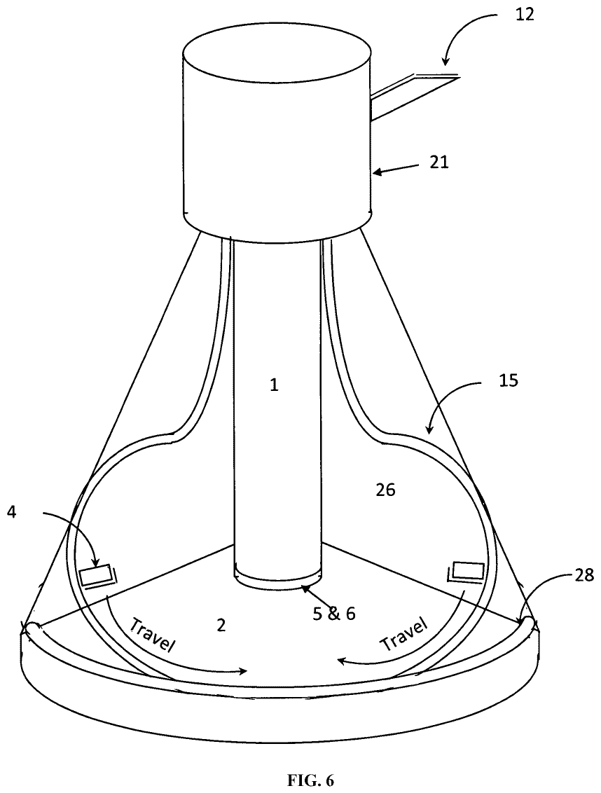

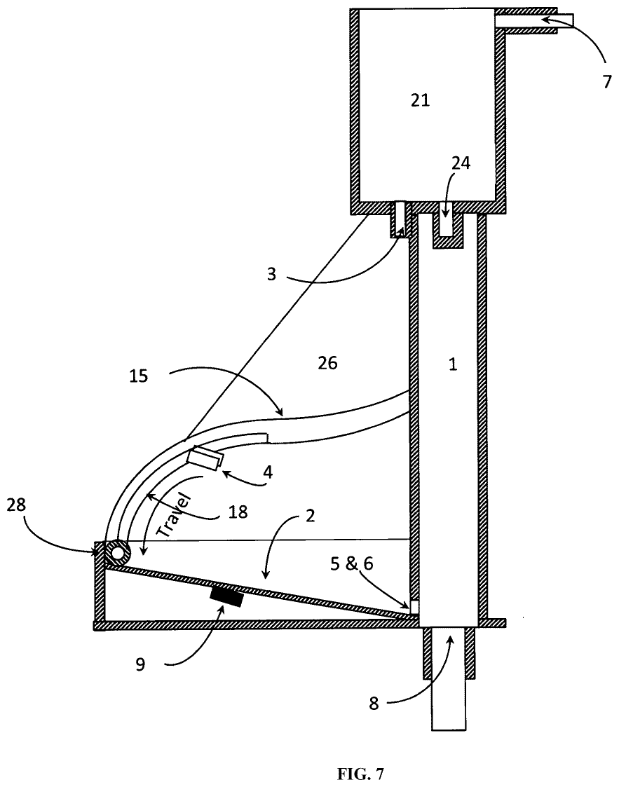

Referring to FIG. 6 the Isometric of Small to Medium Size bread unit, Shows the complete unit which looks like an oversize urinal #1 the urinal post is located towards the back of the semicircle #2 defecation base plate set at a slight incline and covered with artificial grass. #21 the water tank sits atop the #1 urination post to one side is #12 a flushing handle on either sides of #1 the urination post underneath the #21 water tank are #15 the feces cleaning tubs to provide water to #4 the feces cleaning nozzles. #4 the feces cleaning nuzzles travel across #2 the defecation surface when water is applied this mechanism is explained in FIG. to. #28 shows a lip around the front of the unit to prevent spillage and house #15 the tube that #4 the feces cleaning nozzle travel through while cleaning #2 the defecating surface. On the back there is #26 a wall to protect the wall the unit is mounted against from spillage. After a Dog has defected and/or urinated on the unit you simply pull #12 the flushing handle or have a unit with FIG. 7 #9 an electric detector, which will detect weight. Manually flushing the unit producer to clean the unit.

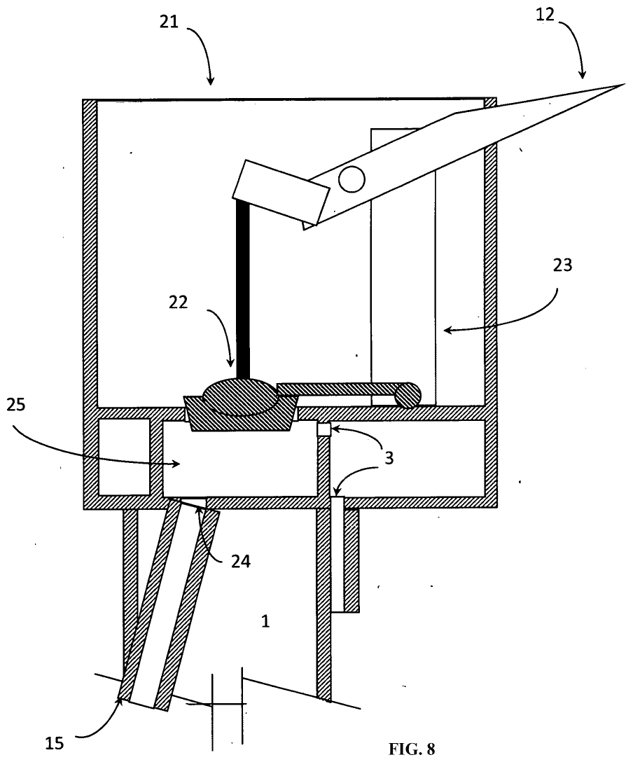

FIG. 8 is started by pulling #12 the flushing handle which pulls on #22 the flapper inside #21 the water tank mounted atop #1 the urination post, allowing water flow from the top of the water tank into the #25 lower section, were the water goes through openings #24 into #15 the feces cleaning tubs also using #3 an overflow opening will wash over and clean urine off #1 the urination post Shown in also in FIG. I.

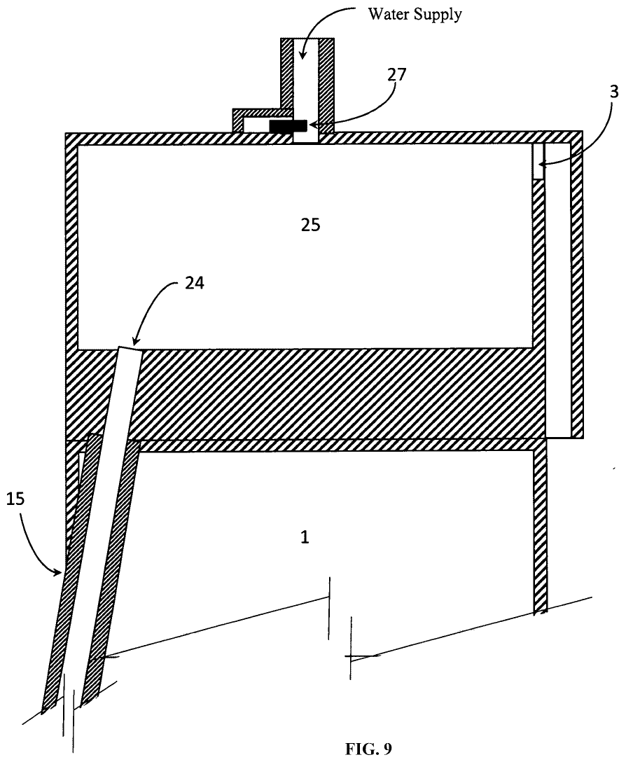

FIG. 9 Shows automatic electronic option illustrating how #27 a value will open from a water supply. This will remain open for a certain period chime to allow the process to complete. FIG. 7 Show #9 a weight switch under the defecation plate to trigger the start of the process.

When the dog first stands on the unit the switch gives a signal to the circuit. When it steps off, a second signal is sent. When the second signal is received FIG. 9 #27 Value is open and a timer will start and after a certain amount of time #27 Value is closed. The water is supplied to the urination post via #3 through the overflow and the defecation plate via #24 the openings in the bottom of the #25 lower tank, there will no need for an upper fill tank as in the manual method.

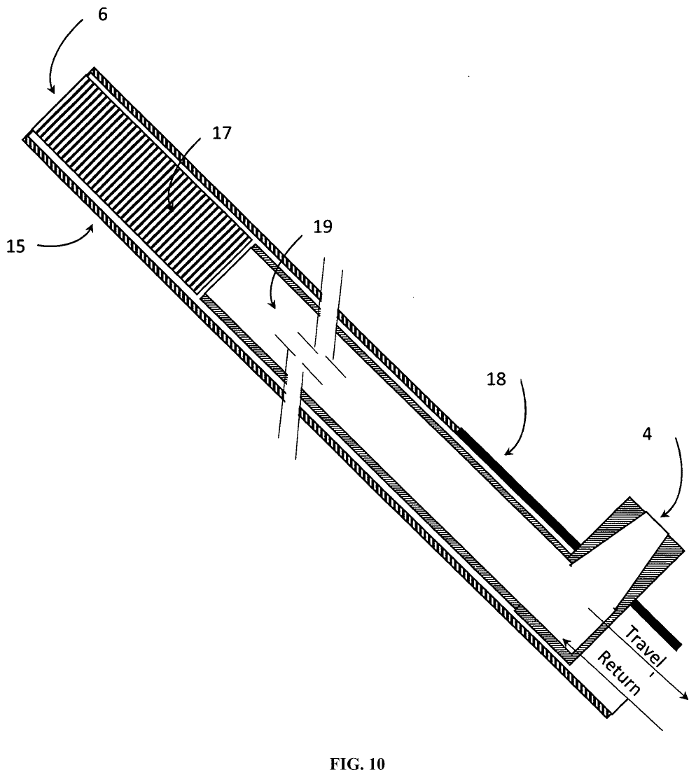

FIG. 10 Sectional view of water moving feces cleaning nozzle mechanism. When the water enters the #15 feces spraying tubes through #6 the openings the water will push the #19 inner tube through #15 the out tube as it travels the water will be forced through #4 a spray nozzle which will traveling through #18 the cut out, those it will clean #2 the defecation base plat and send the waste down #6 the drain. There will be #17 a spring inside #15 the tube to return the spray nozzles to their original positions when the cycle is complete. FIG. 6 & FIG. 7 show #15 the outer tub which is path #4 the feces cleaning spray nozzles will follow.

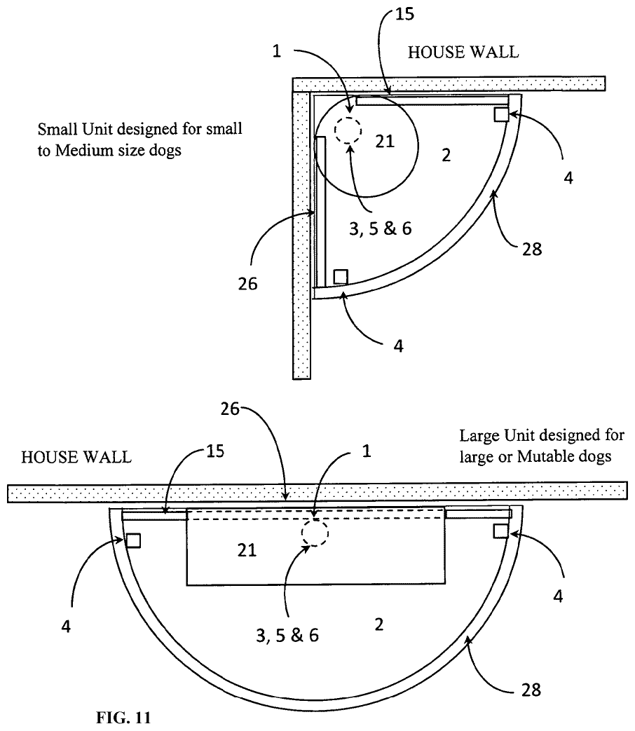

FIG. 11 Floor plan of Indoor version of small to Medium dog and The Large or Multiple Dogs toilets. The units are designed to be place against a wall in a bathroom they are designed to look like oversized urinals so as to look like they belong in a home. These drawings show 2 layouts. You can clearly see #2 the defection base is a semicircle, #28 the front lip were #4 the feces cleaning nuzzle will travel through to clean the #2 the defecation base. Under and in front of the #1 urination post which is mounted towards the back is the drain for both #5 urine and #6 waste. On top of #1 the urination post is #21 the water tank and on the front is #3 the overflow to start the water flow to clean #1 the urination post. On the back in front #26 the protective walls you see #15 the tubs that the water to clean the feces and #16 inner tubes and finally #4 the feces cleaning nozzles travel.

What is claimed is:

1. An outdoor pet toilet comprising:
a base, comprising a top surface, a bottom surface and a perimeter, wherein said base comprises an outer rim and a base plate having an outer perimeter edge, wherein the base plate comprises a central void, through which a urination post extends, wherein the base plate is a substantially flat surface that slopes at an approximately uniform downward angle via a slight gradation from the central void to the outer perimeter edge;
the urination post extending through the central void at an approximately perpendicular angle to the top surface;
at least one nozzle coupled to the post and coupled to a water line, which extends through a hollow portion of the urination post and below the top surface, wherein a terminal end of the water line is configured to be coupled to an underground, pressurized water source;
a drain gap between the outer perimeter edge and the outer rim, wherein said drain gap is configured to be sufficient to permit a passing of animal defecate from the top surface through the drain gap responsive to an application of pressurized water flowing from the water source, through the water line, through the nozzle, across the slight gradation, and into the drain gap;
a drain positioned below the drain gap;
and,
wherein the outdoor pet toilet is configured to be partially buried in an outdoor ground surface, such that:
the top surface is approximately horizontal to and approximately level with the outdoor ground surface,
the drain gap is exposed, and
the drain is buried underground.

2. The outdoor pet toilet of claim 1, wherein the perimeter, the outer rim, and the outer perimeter edge are approximately circular, and wherein the urination post extends through approximately a center of each.

3. The outdoor pet toilet of claim 1, wherein a top surface of top surface is covered with artificial grass.

4. The outdoor pet toilet of claim 1, wherein the outdoor pet toilet is configured to be mounted adjacent to a wall, wherein the perimeter is approximately a half circle with a diameter edge parallel to an edge of the wall, wherein the at least one nozzle is configured to spray in an approximately one hundred and eight degree arc from the urinal post in a direction opposite the wall.

5. The outdoor pet toilet of claim 1, wherein the outdoor pet toilet is configured to be mounted adjacent to a corner, wherein the perimeter is approximately a quarter circle with a edges parallel to edges of the corner, wherein the at least one nozzle is configured to spray in an approximately ninety degree arc from the urinal post in a direction opposite the corner.

6. The outdoor pet toilet of claim 1, wherein the top surface of the base comprises a heating component configured to heat the top surface.

7. The outdoor pet toilet of claim 1, wherein the post comprises a non-conductive surface.

8. The outdoor pet toilet of claim 1, further comprising a weight sensor, wherein the weight sensor is designed to trigger the at least one nozzle to spray.

9. The outdoor pet toilet of claim 1, further comprising a liquid coolant cavity coupled to the bottom surface of the base, and a liquid coolant reservoir coupled to the liquid coolant cavity, wherein the liquid coolant cavity is designed to at least one of heating and cooling the top surface of the base, and the liquid coolant reservoir is designed to provide liquid coolant to the liquid coolant cavity.

10. The outdoor pet toilet of claim 1, wherein the top surface of the base comprises a cooling component configured to cool the top surface.

11. The outdoor pet toilet of claim 1, wherein the pressurized water source is coupled to a city water supply, and wherein the drain is coupled to a city sewer.

12. An outdoor pet toilet comprising:
a base, comprising a top surface, a bottom surface and a perimeter, wherein said base comprises an outer rim, wherein the base plate comprises a central void, through which a urination post extends, wherein the base plate is a substantially flat surface that slopes at an approximately uniform downward angle via a slight gradation from the outer rim to the central void;
the urination post extending through the central void at an approximately perpendicular angle to the top surface;
at least one nozzle coupled to the perimeter of the base and to a water line that extends below the top surface, wherein a terminal end of the water line is configured to be coupled to an underground, pressurized water source;
a drain gap, which is an outer part of the central void that remains a void after the urination post extends through, wherein said drain gap is configured to be sufficient to permit a passing of animal defecate from the top surface through the drain gap responsive to an application of pressurized water flowing from the water source, through the water line, through the nozzle, across the slight gradation, and into the drain gap; and
a drain positioned below the drain gap, wherein the outdoor pet toilet is configured to be partially buried in an outdoor ground surface, such that:
the top surface is approximately horizontal to and approximately level with the outdoor ground surface,
the drain gap is exposed, and
the drain is buried underground.

13. The pet toilet of claim 12, further comprising a pedal configured to activate a flow through the at least one nozzle.

14. The pet toilet of claim 12, further comprising a liquid coolant cavity coupled to the bottom surface of the base, and a liquid coolant reservoir coupled to the liquid coolant cavity, wherein the liquid coolant cavity is designed to heating and cooling the top surface of the base, and the liquid coolant reservoir is designed to provide liquid coolant to the liquid coolant cavity.

15. The pet toilet of claim 12, wherein the pressurized water source is coupled to the urination post, and the drain is coupled to a city sewer.

16. The pet toilet of claim 12, wherein the top surface of the base comprises at least one of turf and artificial grass.

17. The pet toilet of claim 15, wherein the urination post comprises a non-conductive surface.

18. A pet toilet comprising:
a base comprising a top surface, where animals defecate, a bottom surface, and a perimeter;
a liquid coolant cavity coupled to the bottom surface of the base, and
a liquid coolant reservoir coupled to the liquid coolant cavity, wherein the liquid coolant cavity is designed to at least one of heat and cool the top surface of the base, and the liquid coolant reservoir is designed to provide liquid coolant to the liquid coolant cavity.

19. The pet toilet of claim 18, further comprising:
a urination post extending through the top surface at an approximately perpendicular angle;
at least one nozzle coupled to the urination post and coupled to a water line, which extends through a hollow portion of the urination post and below the top surface, wherein a terminal end of the water line is configured to be coupled to an underground, pressurized water source; and
a drain gap in the top surface, wherein said drain gap is configured to be sufficient to permit a passing animal defecate from the top surface through the gap responsive to an application of pressurized water flowing from the water source, through the water line, through the nozzle, across the top surface, and into the drain gap.
